(19) United States
(12) Patent Application Publication
(10) Pub. No.: US 2021/0295227 A1
(43) Pub. Date: Sep. 23, 2021

(54) MULTI-ENERGY DISTRIBUTED TRANSACTION AND SMART CONTRACT DESIGN METHOD BASED ON ETHEREUM PRIVATE CHAIN

(71) Applicants: Xi'an Jiaotong University, Xi'an City (CN); Northwest Branch of State Grid Corporation of China, Xi'an City (CN); Electric Power Research Institute of State Grid Shaanxi Electric Power Company, Xi'an City (CN)

(72) Inventors: Tao DING, Shanghai (CN); Jiangbin DONG, Xi'an City (CN); Chenggang MU, Xi'an City (CN); Ming QU, Xi'an City (CN); Ke'er NING, Xi'an City (CN); Xiaobo Dong, Xi'an City (CN); Jie QI, Xi'an City (CN); Xiaomeng ZHANG, Xi'an City (CN); Yuankang HE, Xi'an City (CN); Tian'en CHEN, Xi'an City (CN); Yongqing WANG, Xi'an City (CN); Jian LIU, Xi'an City (CN)

(21) Appl. No.: 16/950,364

(22) Filed: Nov. 17, 2020

(30) Foreign Application Priority Data
Mar. 17, 2020 (CN) 20120101873439

(51) Int. Cl. G06Q 10/06; H02J 3/28; H02J 3/00; H04L 9/06

(52) U.S. Cl. CPC G06Q 10/06315; H02J 3/28; H02J 3/003; G06Q 50/06; H04L 9/0643; H04L 2209/38; H02J 3/004

(57) ABSTRACT

This invention involves a multi-energy distributed transaction and smart contract design method based on the Ethereum private chain. This method includes the following steps: 1) Setting the genesis node of the smart contract as an administrator node, while other nodes as user nodes; 2) Distinguishing system functions and account permissions between administrator nodes and user nodes. Only administrator nodes can add or delete the types of tradable energy in the blockchain through the energy switch function; 3) The user realizes multiple energy transactions at the same time, and the smart contract matches the information released by users based on the market supply and demand situation. This invention can effectively solve the problems of the centralization of the current energy trading system and insufficient security protection. At the same time, it provides an effective solution to the current limited development of blockchain technology in the field of multi-energy trading.

### FIELD OF THE INVENTION

The invention belongs to the field of multi-energy coupling distributed transactions and relates to a multi-energy distributed transaction and smart contract design method based on an Ethereum private chain.

### BACKGROUND OF THE INVENTION

With the further reform of China's energy market, the encouraged policy is to promote the distributed trading of energy and form a free trading competitive market. Taking electric energy as an example, with the liberalization of the electricity sales side, traditional electric energy consumers can not only consume energy but also become producers and consumers in the future to achieve the purpose of improving the efficiency of energy transactions and reducing the energy consumption of the transmission process. In such a new energy market, the types of participants become more abundant. Producers and consumers are no longer absolute, and users will participate more in energy market transactions as producers and consumers.

However, traditional transaction centers need to continuously maintain and manage transaction data and transaction processes, the operating costs are high, and there are unavoidable trust issues. Centralized databases also have the risk of transaction data being tampered, which directly threatens the security of transaction data and the interests of both parties in the transactions. Blockchain technology provides an effective way to solve this problem, but the blockchain technology that has been developed for energy transactions so far still has certain limitations, such as the inability to trade multiple energy sources simultaneously, and the lack of weak centralization node such as administrators. The traditional method cannot effectively achieve distributed transactions, and the transaction matching model cannot consider different market conditions, which hinders the development of blockchain technology in the energy field.

### SUMMARY OF THE INVENTION

To overcome the above-mentioned problems, this invention is aimed to provide a multi-energy distributed transaction and smart contract design method based on the Ethereum private chain, which solves the problems existing in the existing energy transaction and provides a great advantage in solving problems for blockchain technology in the energy transaction field.

To achieve the objective above, this invention adopts the following technical solutions:

A multi-energy distributed transaction and smart contract design method based on the Ethereum private chain, including the following steps:

1) Setting the genesis node of the smart contract as an administrator node and other nodes as user nodes;

2) Distinguishing the system functions and account permissions of the administrator node and the user node, and only the administrator node can add or delete the tradable energy types in the blockchain through the energy switch function;

3) The user realizes the simultaneous transactions of multiple energy sources. The smart contract matches the information released by users according to the market supply and demand.

Further, the above step 2) includes the following steps:

201) Add energy
By setting the address of the contract creator as the administrator address, when calling the contract, the method of identity verification in the Ethereum smart contract is used to determine whether the account address is an administrator account to create energy; By inserting energy ID (energy identity) field into the created energy structure, each transaction information is added with an energy identifier corresponding to the transaction energy. In the transaction process, different energies are classified according to the identifiers and complete the transaction.
202) Delete energy
The smart contract cannot directly delete arrays. Design energy enable module that can only be called by the administrator, which is marked permitted for all newly added energy. When deletion is required, the administrator calls the enable module to change the energy permitted status; When the user publishes a transaction, the smart contract will first determine whether the energy is turned on according to the enable module, then execute a trading order, getting the same effect as deleting energy.

Further, the above step 3) includes the following steps:

301) Users publish transactions;
302) Initial preparation before contract matching;
303) Determine the matching price;
304) Determine the trading amount;

### 305) Matchmaking

Further, the above step 301) specifically includes:

The smart contract first obtains the enable status of all energies and then returns the open energies to the users. The users can choose the type of energy they want to trade, and at the same time choose the identity of the buyer or seller to determine the number of transactions and the expected transaction price.

Further, the above step 302) specifically includes:

After receiving the transaction information published by the user, the smart contract first classifies all transactions by the energy identifier and then confirms whether the market is an oversupply or in short supply according to the comparison between the demand and supply of a certain energy.

Further, the above step 303) specifically includes:

If oversupply, the releases where the seller's quotation is lower than the buyer's quotation will be screened out, and the sellers will be sorted according to the corresponding quotations from low to high. If the quotations are the same, the first quotation will be ranked first. The transaction is concluded at the seller's quotation according to the sequence; If in short supply, the releases where the buyer's quotation is higher than the seller's quotation will be screened out, and the buyers are sorted according to the corresponding quotations from high to low. If the quotations are the same, the first quotation will be ranked first. The transaction is concluded at the seller's quotation according to the sequence.

Further, the above step 304) specifically includes:

For a market that is oversupply, the sellers will buy according to the seller's quotation from low to high; for a market that is in short supply, it will be sold according to the buyer's quotation from high to low.

Further, the above step 305) specifically includes:

The matching performs until the transactions on the market that meets the quotation conditions has been fully matched, and the remaining transactions in the market cannot meet the quotation conditions of both parties because the consumer's quotation is too low or the seller's quotation is too high, the matching ends.

The beneficial effects of the present invention are embodied in:

(1) This invention proposes a smart contract design method based on Ethereum blockchain technology. This method can effectively solve the problems of the centralization of the current energy trading system and insufficient security protection. At the same time, it puts forward effective measures to solve the problem of limited development in the area of multiple energies trading on the blockchain;
(2) This invention enables energy transactions to be deployed in a distributed blockchain to enhance the security and non-tamper ability of the transaction. At the same time, it contains the function of adding and deleting energy, which can realize the common transaction of multiple energy systems. In energy transaction matching, a model of matching based on supply and demand is proposed to fully match and meet the quotation needs of both sides;
(3) This invention can overcome the difficulty of distributing complex application of blockchain in the field of energy transactions, making it possible for multi-energy coupled distributed transactions;
(4) This method proposed in this invention can be used in distributed transactions and energy internet applications. Engineers can carry out relevant research work accordingly.

### BRIEF DESCRIPTION OF THE DRAWINGS

FIG. 1: The structure of the smart contract of this invention;

FIG. 2: The transaction matching process of the present invention.

### DETAILED DESCRIPTION OF THE INVENTION

To make the objectives, technical solutions, and advantages of the embodiments of this invention clear, the technical solutions of this invention will be described along with the figures in the embodiments. The described embodiments are parts of the embodiments of the present invention, not the whole embodiments. Based on the embodiments of this invention, all other embodiments obtained by those of ordinary skill in the art without creative work shall fall within the protection scope of the present invention. Therefore, the following detailed description of the embodiments of this invention provided in the accompanying figures is not intended to limit the scope of the claimed invention, but merely represents selected embodiments of the present invention.

According to the energy management method proposed by this invention, smart contracts can be written with the Solidity language to complete the design of the multi-energy transaction smart contract system architecture. The following text first describes the implementation of the energy management function of the administrator node proposed in this invention, and then introduces the smart contract architecture of multi-energy coupled distributed transactions based on this function and the transaction matching model based on the market supply and demand relationship in detail.

(1) The Design Method of the Authentication of the Administrator Node and the Addition and Deletion of Energy

(1.1) Administrator User Initialization

First, define the system administrator address, which is naturally supported by Ethereum smart contract, in the smart contract. Then in the smart contract constructor, store the submitter address as the address of the system administrator address. Next, design the function modifier “admin-only” which reject any execution except the administrator. This will be used for automatically checking the subsequent execution of the energy addition function and the energy enable function.

(1.2) Energy Addition

The administrator inputs the name of the energy to be added, the energy publisher, and the energy accuracy. With these arguments transmitted, verified by the “admin-only” modifier, then it can be executed and these data will be stored into the smart contract. At this time, the creation of an energy event is emitted. The energy is added to the energy list and is assigned with an ID as a unique energy identifier. At the same time, the energy status is marked enable. Then the process is ended.

(1.3) Energy Closing

Due to some technical reasons, any space allocated in the smart contract may not be free, which makes the energy unable to be removed. We designed a Boolean value to mark the status of energy, true as enable and false as disable. To close energy, the administrator inputs the energy ID and false status and transmitted to the smart contract, verified by the “admin-only” modifier, the status of corresponding energy is set to disable, then end the process.

(1.4) Fetching the Energy List

This operation needs no authentication, which means anyone able to access the network is permitted to fetch these data. The energy list data are stored in scattered map structure and will be marshaled as a structure list immediately to transmit back to the user. An additional “offset-count” parameter is accepted if provided to select a subset of the list, with default 0 offset and specified count.

(1.5) Trade Matching

The trade matching process begins with the marshaled energy list. Any “ask” or “bid” is spread into a different area to complete the matching process, which will be described later in this text.

(2) Multi-Energy Distributed Transaction Smart Contract Design Method

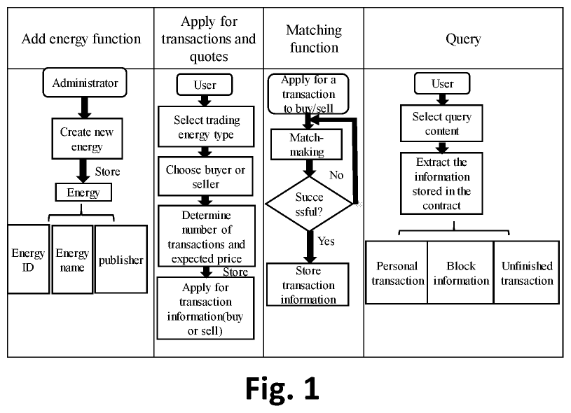

This section introduces the 5 main functions in smart contract design according to the functional division of the invented trading system. The structure and function of the function are shown in FIG. 1.

(2.1) Energy Addition

Adding energy function has been partially introduced in (1), the feature of which is that it can only be called by the administrator. The system can determine whether the caller address is an administrator or not. The administrator can create multiple energies according to the requirements. The energy information includes energy name, energy unit, publisher, and energy accuracy. After the creation is successful, users can conduct related energy transactions.

(2.2) Registration

This function is executed in the user's local environment, which means no network is needed to register. The blockchain account address and private key are generated in this execution. Any submission will be signed with the user's private key, and the corresponding automatically signs process is usually known as “login”. This private key is the identity certificate for users to enter the energy trading platform to achieve various functions.

(2.3) Apply for Publishing and Trading

The publish is divided into “ask” type, for consumer, and “bid” type, for the seller. Any user in this system is permitted to publish an ask or a bid to declare their demand. The user packed the energy ID, amount, and expected price and signed them and transmitted them to the smart contract, to publish their demand and request the system to satisfy their demand.

After confirmation, the information will be stored in the structure of the smart contract for sale or purchase. At this time, the user only needs to wait for the system to match.

(2.4) Trade Matching

This process will be triggered after some publish were stored in the system. The system will sort the application transaction information released by a variety of practical factors, such as the energy type, price, transaction amount, etc., and transmitted the transaction information to the smart contract to meet the needs of multi-party transactions. The transaction logs are stored in the smart contract and can be viewed by anyone in the system. The detailed process will be further described in section 3.

(2.5) Query

This function builds an objective and transparent service query system based on the above transaction information structure. Users can send requests to smart contracts through their blockchain account addresses and private key, call the function that fetches transaction information stored in the smart contract ranged of al the blockchain, including transaction energy, transaction parties, transaction amount, transaction price, etc. At the same time, the contract can also filter information based on the caller's blockchain address, and query the flow of personal transactions, including completed and uncompleted transactions.

(3) Transaction Matching Model Based on Market Supply and Demand

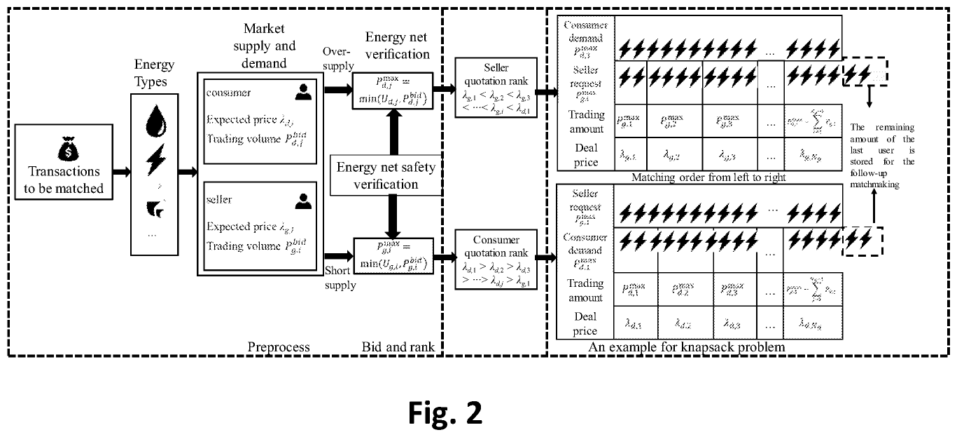

FIG. 2 shows the method of the matching process in the multi-energy coupled transaction system of the present invention. In the matching stage, the main task of the smart contract is to meet the user's quotation requirements for issuing transactions and save more costs for both users. At the same time, more transactions can be successfully matched, and the final transaction price can be determined according to the market quotation and the relationship between supply and demand.

The idea of the transaction matching model is as follows:

Suppose the expected price of the buyer i is Bᵢ, and the applied transaction volume is xᵢ; the expected price of the seller B is Sⱼ, and the applied transaction volume is yⱼ. The pending transaction originates from multiple participants in the energy trading platform, and the quotations of buyers and sellers can be generated at any time. The prices match, they can be traded. This module is attributed to a continuous double auction mechanism.

First, classify different types of energy, such as water, electricity, and gas.

Second, confirm the supply and demand relationship at this time based on the current market volume.

When oversupply, when the number of sellers is more than the number of buyers, assume the number of buyers is 1 at this time (it is also true from the actual situation, if the buyers meet the conditions, they have already completed the transaction, and will not still exist in the oversupplied market), Filter out the sellers and their quotations are lower than the buyer, the number is n, and sort the sellers according to the corresponding quotations from low to high. If the quotations are the same, the first quotation will come first. Next, math the transaction volume applied by the user. Starting from the first seller, if the seller's applied transaction volume is greater than the consumer's, the consumer's applied transaction volume will be used for the transaction, with the transaction price being the seller's offer. If the first seller's applied transaction volume is less, his applied transaction volume will be bought in all. The rest of the transaction will turn to the next seller until the consumer's applied transaction volume is satisfied. Therefore, the total price of energy purchased by the consumer is

$$W = {\sum }_{j = 1}^{n} {S}_{j} {y}_{j} , and {x}_{1} = {\sum }_{j = 1}^{n} {y}_{j} .$$

When supply is less than demand, i.e., the number of sellers is less than the number of consumers, assuming that the number of sellers is 1, select the consumers whose quotations are higher than the sellers, the number of which is m, and sort the consumers from high to low according to the corresponding quotations. The consumer who bids first will be ranked higher when some prices are the same. Next, match the transaction volume requested by the user. Starting from the first consumer, if the consumer's applied transaction volume is greater than the seller, the seller's application volume will be used for the transaction, with the transaction price being the consumer's quotation. If the buyer's application volume is less, the consumer buys all the amount requested by the buyer and turn to the second consumer until the seller's requested transaction amount is reached. Therefore, the total price of energy sold by the seller is

$$W = {\sum }_{i = 1}^{n} {B}_{i} {x}_{i} , and {y}_{1} = {\sum }_{i = 1}^{n} {x}_{i} .$$

Such a matching process always takes the user's quotation as the primary condition, which is in line with the actual market conditions. Different energy sources are matched in parallel, and the matchmaking process dynamically follows the market situation. So far, a multi-energy coupling transaction system based on blockchain technology has been built, according to the energy management method of this invention.

The above are only embodiments of this invention and are not intended to limit the scope of protection of this invention. Any equivalent structure or equivalent process transformation made using the contents of the description and drawings of the present invention, or directly or indirectly applied in other related system fields, and this is included in the protection scope of this invention.

1. A multi-energy distributed transaction and smart contract design method based on the Ethereum private chain, characterized in that, includes the following steps:
1) Setting the genesis node of the smart contract as an administrator node and other nodes as user nodes;
2) Distinguishing the system functions and account permissions of the administrator node and the user node, and only the administrator node can add or delete the tradable energy types in the blockchain through the energy switch function;
3) The user realizes the simultaneous transactions of multiple energy sources. The smart contract matches the information released by users according to the market supply and demand.

2. A multi-energy distributed transaction and smart contract design method based on the Ethereum private chain according to claim 1, step 2) specifically includes the following steps:
201) Add energy
By setting the address of the contract creator as the administrator address, when calling the contract, the method of identity verification in the Ethereum smart contract is used to determine whether the account address is an administrator account to create energy; By inserting the energy ID field into the created energy structure, each transaction information is added with an energy identifier corresponding to the transaction energy. In the transaction process, different energies are classified according to the identifiers and complete the transaction.
202) Delete energy
The smart contract cannot directly delete arrays. Design energy enable module that can only be called by the administrator, which is marked permitted for all newly added energy. When deletion is required, the administrator calls the enable module to change the energy permitted status; When the user publishes a transaction, the smart contract will first determine whether the energy is turned on according to the energy enable module, then execute a trading order, getting the same effect as deleting energy.

3. A multi-energy distributed transaction and smart contract design method based on the Ethereum private chain according to claim 2, the step 3) specifically includes the following steps:
301) Users publish transactions;
302) Initial preparation before contract matching;
303) Determine the matching price;
304) Determine the trading amount;
305) Matchmaking.

4. A multi-energy distributed transaction and smart contract design method based on the Ethereum private chain according to claim 3, the step 301) specifically includes:
The smart contract first obtains the enable status of all energies and then returns the open energies to the users. The users can choose the type of energy they want to trade, and at the same time choose the identity of the buyer or seller to determine the number of transactions and the expected transaction price.

5. A multi-energy distributed transaction and smart contract design method based on the Ethereum private chain according to claim 4, the step 302) specifically includes:
After receiving the transaction information published by the user, the smart contract first classifies all transactions by the energy identifier and then confirms whether the market is an oversupply or in short supply according to the comparison between the demand and supply of a certain energy.

6. A multi-energy distributed transaction and smart contract design method based on the Ethereum private chain according to claim 5, the step 303) specifically includes:
If oversupply, the releases where the seller's quotation is lower than the buyer's quotation will be screened out, and the sellers will be sorted according to the corresponding quotations from low to high. If the quotations are the same, the first quotation will be ranked first. The transaction is concluded at the seller's quotation according to the sequence; If in short supply, the releases where the buyer's quotation is higher than the seller's quotation will be screened out, and the buyers are sorted according to the corresponding quotations from high to low. If the quotations are the same, the first quotation will be ranked first. The transaction is concluded at the seller's quotation according to the sequence.

7. A multi-energy distributed transaction and smart contract design method based on the Ethereum private chain according to claim 6, the step 304) specifically includes:
For a market that is oversupply, the sellers will buy according to the seller's quotation from low to high; for a market that is in short supply, it will be sold according to the buyer's quotation from high to low.

8. The method for designing multi-energy distributed transactions and smart contracts based on the Ethereum private chain according to claim 7, step 305) specifically includes:
The matching performs until the transactions on the market that meets the quotation conditions has been fully matched, and the remaining transactions in the market cannot meet the quotation conditions of both parties because the consumer's quotation is too low or the seller's quotation is too high, the matching ends.
